(19) United States
(12) Patent Application Publication
(10) Pub. No.: US 2016/0234085 A1
(43) Pub. Date: Aug. 11, 2016

(54) Online Indication Method, Device and System

(71) Applicant: ZTE CORPORATION, Shenzhen (CN)

(72) Inventor: Dan YANG, Shenzhen (CN)

(21) Appl. No.: 14/442,176

(22) PCT Filed: Aug. 9, 2013
(86) PCT No.: PCT/CN2013/081197

§ 371 Date: May 12, 2015

(30) Foreign Application Priority Data
Nov. 12, 2012 (CN) 201210450435.7

(51) Int. Cl. H04L 12/26; H04W 4/14

(52) U.S. Cl. CPC H04L 43/065; H04W 4/14; H04L 43/0817; H04W 84/12

(57) ABSTRACT

Provided are an online indication method, device and system. The method comprises: an online state of each PU in a designated area is checked; and if there is an offline PU, indication information is sent to the offline PU, wherein the indication information is used for indicating to the offline PU to automatically start online. By means of the invention, offline PUs within a certain area may be found according to physical location information of the PUs, and then the above-mentioned offline PUs are triggered by the indication information to be automatically online, so that the problem in the related art that the PUs cannot automatically start online in the case of emergency after being offline is solved, and thus, there is no need for users to start the PUs manually.

### TECHNICAL FIELD

The invention relates to the field of communications, and in particular to an online indication method, device and system.

### BACKGROUND

A video monitoring system is a system which manages a front end camera, and can forward real-time video code streams of the front end camera to a client for the client to watch according to a set authority, and at the same time, can realize functions, such as real-time video recording according to the setting. As science and technology become more and more developed, people's safety awareness becomes higher, and there are also more and more monitoring requirements on the ambient environment thereof, and the application of the video monitoring system also becomes more and more wide. Especially in the field of national securities, the video monitoring system even plays an irreplaceable role.

A front end video encoder device of a video monitoring system is a PU. In the practical application of a present network, sometimes the situation of PU power off and offline (such as a power failure) is met, and under the situation, if wanting to re-start the PU, it requires to go to a position where the PU is located and to start manually, which is very inconvenient. Especially PUs of the present network are all distributed in different geographical positions, which is very troublesome. In addition, under some rather emergency situations, if a PU of a camera in a key position is power off and offline which causes interruption of real-time monitoring or recording, it may bring very severe consequences. For example, if a certain criminal suspect appears in a certain area, all PUs in the area are required to be in working states, and if a PU therein is power off and offline at the time and cannot provide a monitoring service, then it may cause the criminal suspect to escape.

With regard to the problem in the relevant technology that a PU cannot automatically starts online when an emergency situation is met after offline, an effective solution has not been proposed yet at present.

### SUMMARY

With regard to the problem in the relevant technology that a PU cannot automatically starts online when an emergency situation is met after offline, the invention provides an online indication method, device and system so as to at least solve the above-mentioned problem.

According to one aspect of the invention, an online indication method is provided, and the method comprises: checking an online state of each PU (video encoder) in a designated area; and if there is at least one offline PU, sending indication information to the at least one offline PU, wherein the indication information is used for indicating to the above-mentioned offline PU to automatically start online.

Before checking the online state of the PUs in the above-mentioned designated area, the above-mentioned method further comprises: receiving an alarm message of a PU; and searching for the above-mentioned each PU in the designated area where the above-mentioned PU is located.

Before receiving the alarm message of the above-mentioned PU, the above-mentioned method further comprises: receiving PU list information reported by any PU in a video monitoring system, wherein the above-mentioned PU list information records information about each PU in the designated area where the above-mentioned any PU is located.

Before receiving the above-mentioned PU list information reported by the above-mentioned any PU, the above-mentioned method further comprises: the above-mentioned any PU searching for PUs which are located in the area thereof; the above-mentioned any PU sending a request message to at least one searched PU, wherein the above-mentioned request message is used for requesting to acquire at least one identity (ID) of the searched PU mentioned above; and the above-mentioned any PU constructing the above-mentioned PU list information according to the at least one acquired ID mentioned above.

Searching for the above-mentioned each PU in the area where the above-mentioned PU is located comprises: according to the above-mentioned PU list information, searching for the above-mentioned each PU in the designated area where the above-mentioned PU is located.

After receiving the above-mentioned PU list information reported by the above-mentioned any PU, the above-mentioned method further comprises: updating the above-mentioned PU list information corresponding to the above-mentioned any PU.

Sending the above-mentioned indication information to the above-mentioned offline PU comprises: using a manner of inputting a mobile user number of the above-mentioned offline PU to send, via a short message interface, the above-mentioned indication information to the above-mentioned offline PU.

Sending the above-mentioned indication information to the above-mentioned offline PU comprises: sending the above-mentioned indication information to the above-mentioned offline PU through a mobile network.

The above-mentioned any PU searching for a PU which is located in the area thereof comprises: the above-mentioned any PU searching, through Wireless Fidelity (WIFI), for a PU which is located in the area thereof.

According to another aspect of the invention, an online indication device is provided, and the device comprises: a state checking component configured to check the online state of each PU (video encoder) in a designated area; and an online indication component configured to, if the above-mentioned state checking component checks that there is an offline PU, send indication information to the offline PU, wherein the indication information is used for indicating that the offline PU automatically starts online.

The above-mentioned device further comprises: an alarm receiving component configured to receive an alarm message of the PU; and a searching component configured to search for the above-mentioned each PU in the designated area where the above-mentioned PU is located.

The above-mentioned device further comprises: a list receiving component configured to receive PU list information reported by any PU in a video monitoring system, wherein the above-mentioned PU list information records information about each PU in a designated area where the above-mentioned any PU is located.

The above-mentioned searching component comprises: a searching element configured to, through the above-mentioned PU list information, search for the above-mentioned each PU in the designated area where the above-mentioned PU is located.

The above-mentioned device further comprises: a list updating component configured to update the above-mentioned PU list information corresponding to the above-mentioned any PU.

According to still another aspect of the embodiments of the invention, an online indication system is provided, and the system comprises: the above-mentioned online indication device and a (video encoder) PU, and the PU comprises: a searching component configured to search each PU in the area where the above-mentioned PU is located; an identification request component configured to send a request message to each searched PU, wherein the above-mentioned request message is used for requesting acquiring an ID of the above-mentioned each PU; and a list constructing component configured to construct the above-mentioned PU list information according to the acquired ID mentioned above.

The above-mentioned PU further comprises: a list reporting component configured to report the constructed PU list information mentioned above to the above-mentioned online indication device.

In the embodiments of the invention, offline PUs within a certain area may be found according to physical location information of the PUs, and then the above-mentioned offline Pus are trigged by the indication information to be automatically online, so that the problem in the related art that the PUs cannot automatically start online in the case of emergency after being offline is solved, and there is no need for users to start the PUs manually. Therefore, the solution provided by the embodiments of the invention is greatly convenient for the users, and it may ensure that each PU in a critical area is in a normal working state in case of emergency and improve the working performance of the PUs.

### BRIEF DESCRIPTION OF THE DRAWINGS

Drawings, provided for further understanding of the invention and forming a part of the specification, are used to explain the invention together with embodiments of the invention rather than to limit the invention. In the accompanying drawings:

FIG. 1 shows a flowchart of an online indication method according to an embodiment of the invention;

FIG. 2 shows a flowchart of a method for automatically waking a near PU by a video monitoring system after receiving an alarm according to an embodiment of the invention;

FIG. 3 shows a flowchart of a method for searching for near PUs through WIFI by a PU and reporting same to a video monitoring system according to an embodiment of the invention;

FIG. 4 shows a flowchart of a method for automatically triggering a short message to wake and alarm all PUs near a PU according to an embodiment of the invention;

FIG. 5 is a structure diagram of an online indication device according to an embodiment of the invention; and

FIG. 6 is a structure diagram of an online indication system according to an embodiment of the invention.

### DESCRIPTION OF EMBODIMENTS

The preferred embodiments are described in conjunction with the drawings as follows. It should be noted that the embodiments and the characteristics of the embodiments can be combined with each other if no conflict is caused.

The embodiments of the invention provide an online indication method, device and system, and detailed illustration is made below through designated embodiments.

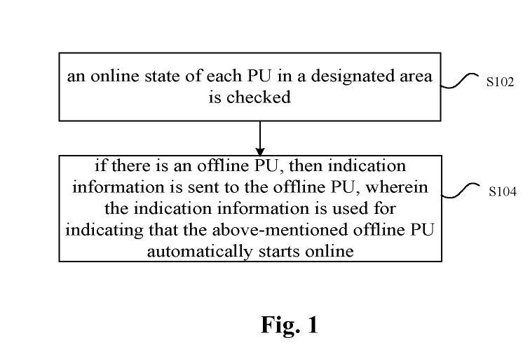

An present embodiment provides an online indication method, and FIG. 1 is a flowchart of an online indication method according to an embodiment of the invention, and as shown in FIG. 1, the method comprises the following steps (step S102-step S104).

Step S102, an online state of each PU in a designated area is checked;

Step S104, if there is an offline PU, then indication information is sent to the offline PU, wherein the indication information is used for indicating that the above-mentioned offline PU automatically starts online.

In the above-mentioned method, offline PUs within a certain area may be found according to physical location information of the PUs, and then the above-mentioned offline PUs are trigged by the indication information to be automatically online, so that the problem in the related art that the PUs cannot automatically start online in the case of emergency after being offline is solved, and thus, there is no need for users to start the PUs manually. The above solution is greatly convenient for the users, and may ensure that all the PUs in a critical area are in a normal working state in case of emergency and improve the working performance of the PUs.

The online indication method provided in the present embodiment is a method that is triggered by alarming and searching for offline PUs in a certain area range according to physical position information of the PUs, and then automatically triggers these PUs to come online through a short message. Firstly, the PU is made to be able to receive a short message or a multimedia message, for example, a SIM card may be installed on the PU so that the PU may receive a short message and may automatically start online after receiving a short message of a certain instruction. In addition, when a video monitoring system opens an account for a PU, a mobile user directory number (Mobile Directory Number, MDN for short) of the PU is required to be set, that is, the video monitoring system may send a short message to the MDN number.

Then, the PU is able to search for a near PU through a wireless network, for example, a WIF component may be installed on the PU (if the PU itself is a wireless PU, then a wife component does not need to be installed independently), so that it may automatically search for the near PU through a WIFI wireless network and report information about the near PU to a video monitoring system for recording same.

When the video monitoring system receives an alarm of a certain PU, all PUs are found in the near area (the range size of the area may be set in advance according to practical situations) recorded in the video monitoring system thereof The video monitoring system checks online states of these PUs, and if there is an offline PU, then the video monitoring system automatically sends a short message of a certain instruction to the PU to trigger it to automatically start online. The above-mentioned manner not only does not need a user to manually start the PU, which is greatly convenient for a user, but also may automatically trigger the PU to start online when there is an emergency, guaranteeing the PU at a key position may be in a working state in case of emergency, and the whole process does not need user intervention and is transparent to the user.

In the above-mentioned step S102, a checking operation of the online state of the PU may be set to periodically execute the operation, or execute the checking operation when a triggering condition is received. The present embodiment provides a preferred embodiment, that is, before checking the online state of the PU in a designated area, the above-mentioned method further comprises: receiving an alarm message of the PU; and after receiving the alarm message, searching for each PU in the designated area where the above-mentioned PU is located. Through the manner, the alarm message of the PU plays the role of triggering to execute a checking operation, and after the PU in the executing area is found, basis is provided for checking the online state of the PU.

Preferably, before receiving the alarm message of the PU, the above-mentioned method may further comprise: receiving PU list information reported by any PU in a video monitoring system, wherein the PU list information records information about each PU in a designated area where any PU is located.

Through the above-mentioned manner, received PU list information provides basis for subsequently searching for the PU in the designated area; preferably, searching for the above-mentioned each PU in the area where the PU is located comprises: according to the above-mentioned PU list information, searching for the above-mentioned each PU in the designated area where the above-mentioned PU is located.

With regard to a constructing process of the PU list information, the present embodiment provides a preferred embodiment, that is, before receiving the PU list information reported by any PU, the above-mentioned method further comprises: any PU searching for a PU which is located in the area thereof; any PU sending a request message to a searched PU, wherein the request message is used for requesting to acquire an ID of the searched PU mentioned above; and the any PU constructing the PU list information according to the acquired ID mentioned above.

After receiving the PU list information reported by any PU, the PU list information corresponding to the PU may be updated, or the PU list information corresponding to other PUs in the PU list information also may be updated, that is, it may be understood as updating the PU list information corresponding to any PU. Through the manner, the accuracy of searching for the PU is improved.

In the above-mentioned step S104, sending the above-mentioned indication information to the offline PU comprises: through a short message or multimedia message interface, using a manner of inputting a mobile user number (for example, an MDN number) of the offline PU to send the above-mentioned indication information to the offline PU. In addition, sending the above-mentioned indication information to the offline PU may comprise: sending the above-mentioned indication information to the offline PU through a mobile network. That is, an SIM card may be installed on the PU, and then the PU may receive the short message or multimedia message through a mobile network. Preferably, any PU searching for a PU which is located in the area thereof comprises: any PU searching for a PU which is located in the area thereof through WIFI. Through the above-mentioned preferred embodiment, the efficiency and accuracy of the online indication method in an application process are improved.

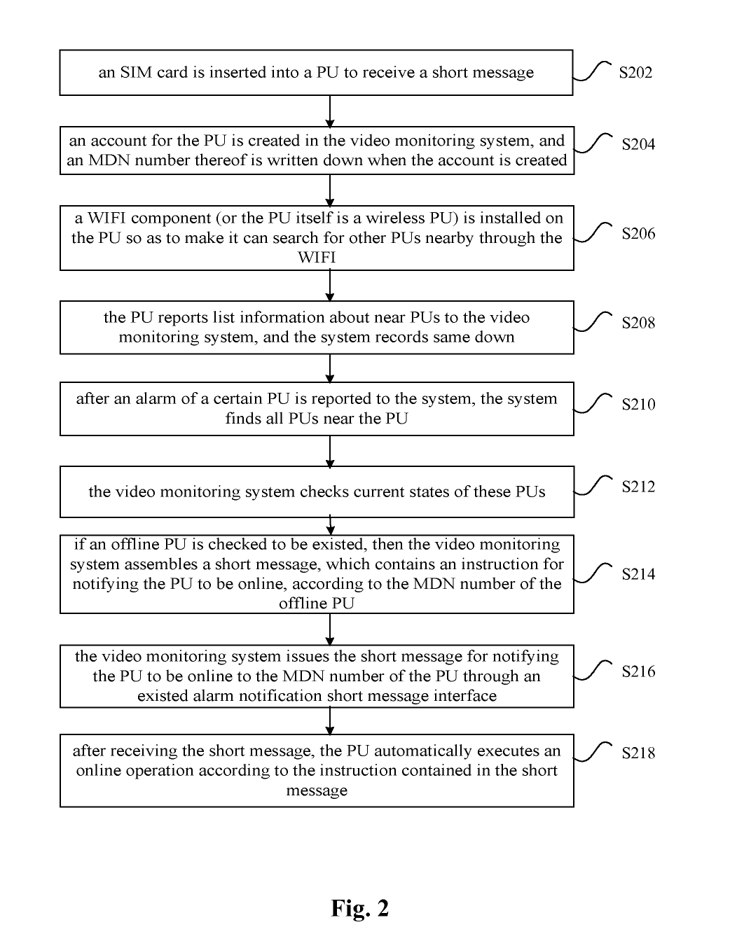

The following describes a method that a video monitoring system automatically wakes a near PU after receiving an alarm in detail. FIG. 2 shows a flowchart of a method for automatically waking a near PU by a video monitoring system after receiving an alarm according to an embodiment of the invention, and as shown in FIG. 2, the method comprises the following steps (step S202-step S218).

Step S202, an SIM card is inserted into a PU to support to receive a short message.

Preferably, the PU needs to have functions, such as accessing a wireless global system for mobile communication (Global System for Mobile Communications, GSM for short) and third generation mobile communication technology (3rd-generation, 3G for short) networks, and have a socket for the SIM card. An ordinary SIM card of a GSM and 3G networks is used to insert into the PU, and in this way, the PU has the function of receiving a short message.

Step S204, an account for the PU is created in the video monitoring system, and the MDN number thereof is written down when the account is created.

Step S206, a WIFI component (or the PU itself is a wireless PU) is installed on the PU so as to make it can search for other PUs nearby through the WIFI. In addition, when an account is created for the PU on an OP account of the video monitoring system, the MDN number of the PU is required to be written in.

Step S208, the PU reports list information about near PUs to the video monitoring system, and the system records same down.

Step S210, after an alarm of a certain PU is reported to the system, the system finds all PUs near the PU.

Step S212, the video monitoring system checks current states of these PUs.

Step S214, if an offline PU is checked to be existed, then the video monitoring system assembles a short message, which contains an instruction for notifying the PU to be online, according to the MDN number of the offline PU.

Step S216, the video monitoring system issues the short message for notifying the PU to be online to the MDN number of the PU through an existed alarm notification short message interface.

Step S218, after receiving the short message, the PU automatically executes an online operation according to the instruction contained in the short message.

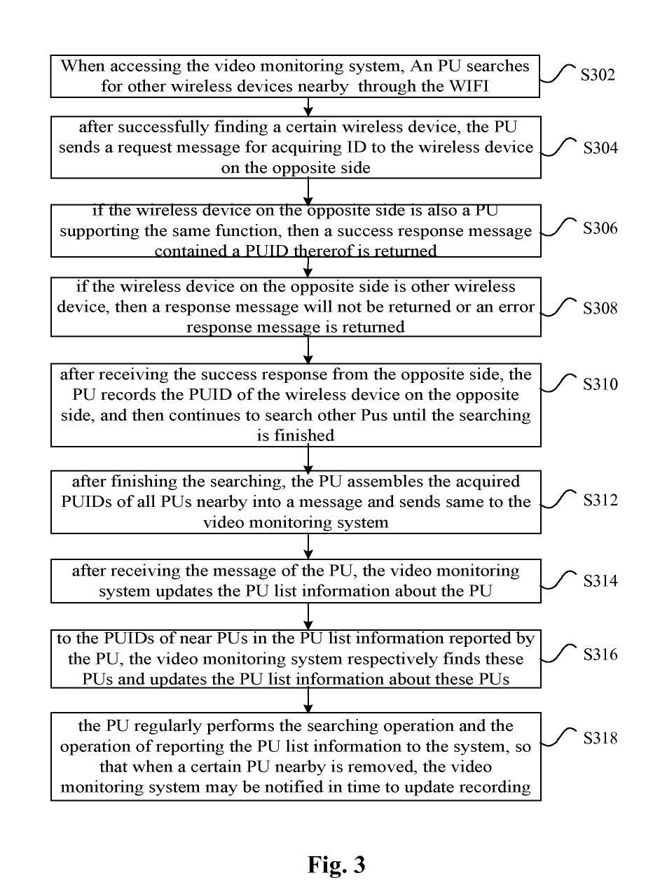

In the above-mentioned steps, searching for near PUs through WIFI and reporting same to the video monitoring system for recording is a very important step, which will be described in detail here. FIG. 3 shows a flowchart of a method for searching for near PUs by a PU through the WIFI by a PC and reporting same to a video monitoring system according to an embodiment of the invention, and as shown in FIG. 3, the method comprises the following steps (step S302-step S318).

Step S302, When the PU accesses the video monitoring system, other wireless devices nearby are searched through the WIFI.

Step S304, after successfully finding a certain wireless device, the PU sends a request message for acquiring the identity (ID for short) (hereinafter simply referred to as PUID) of the wireless device on the opposite side to the wireless device on the opposite side.

Step S306, if the wireless device on the opposite side is also a PU supporting the same function, then a success response message contained a PUID of the wireless device on the opposite side is returned.

Step S308, if the wireless device on the opposite side is other wireless device, then a response message will not be returned or an error response message is returned.

Step S310, after receiving the success response from the opposite side, the PU records the PUID of the wireless device on the opposite side, and then continues to search other Pus until the searching is finished.

Step S312, after finishing the searching, the PU assembles the acquired PUIDs of all PUs nearby into a message and sends same to the video monitoring system.

In the video monitoring system, the record of each PU will save the PU list information about the PU for identifying what other PUs are near the PU. In the PU list information, the PUIDs are used for uniquely identifying the PUs.

Step S314, after receiving the message of the PU, the video monitoring system updates the PU list information about the PU.

Step S316, according to the PUIDs of near PUs in the PU list information reported by the PU, the video monitoring system respectively finds these PUs and updates the PU list information about these PUs.

Step S318, the PU regularly performs the searching operation and the operation of reporting the PU list information to the system, so that when a certain PU nearby is removed, the video monitoring system may be notified in time to update recording.

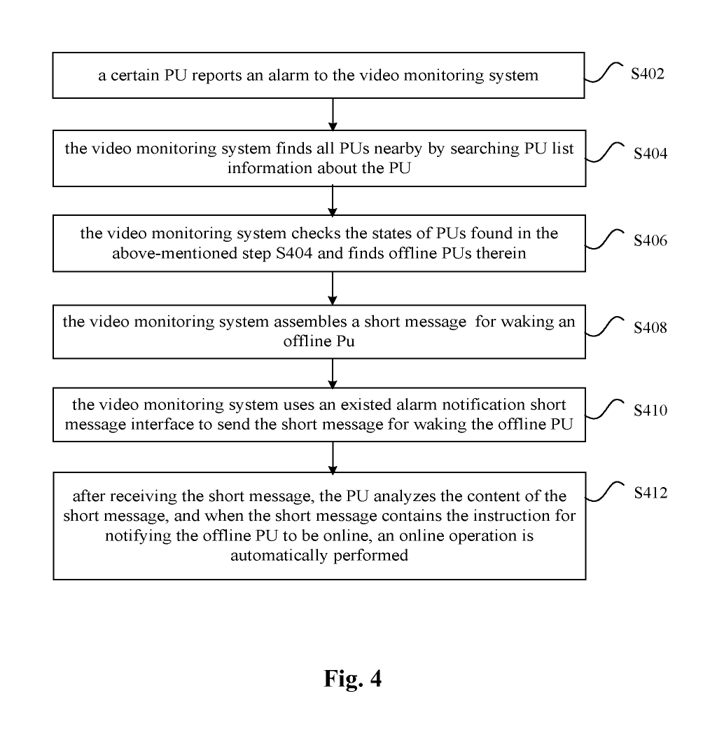

The following describes the flow that when an alarm situation appears and a certain PU reports alarming, the system automatically triggers a short message to wake all PUs near the PU. FIG. 4 shows a flowchart of a method for automatically triggering a short message to wake and alarm all PUs near a PU by a video monitoring system according to an embodiment of the invention, and as shown in FIG. 4, the method comprises the following steps (step S402-step S412).

Step S402, a certain PU reports an alarm to the video monitoring system.

Step S404, the video monitoring system finds all PUs nearby by searching PU list information about the PU.

Step S406, the video monitoring system checks the states of PUs found in the above-mentioned step S404 and finds offline PUs therein.

Step S408, the video monitoring system assembles a short message, which contains an instruction for notifying a offline PU to be online and is used for waking the offline Pu, wherein the content of the instruction is determined by negotiation between the video monitoring system and the PU, such as “sx”; and a target number of the message is the MDN number of each PU found in step S406.

Step S410, the video monitoring system uses an existed alarm notification short message interface to send the short message for waking the offline PU.

Step S412, after receiving the short message, the PU analyzes the content of the short message, and when the short message contains the instruction for notifying the offline PU to be online, an online operation is automatically performed.

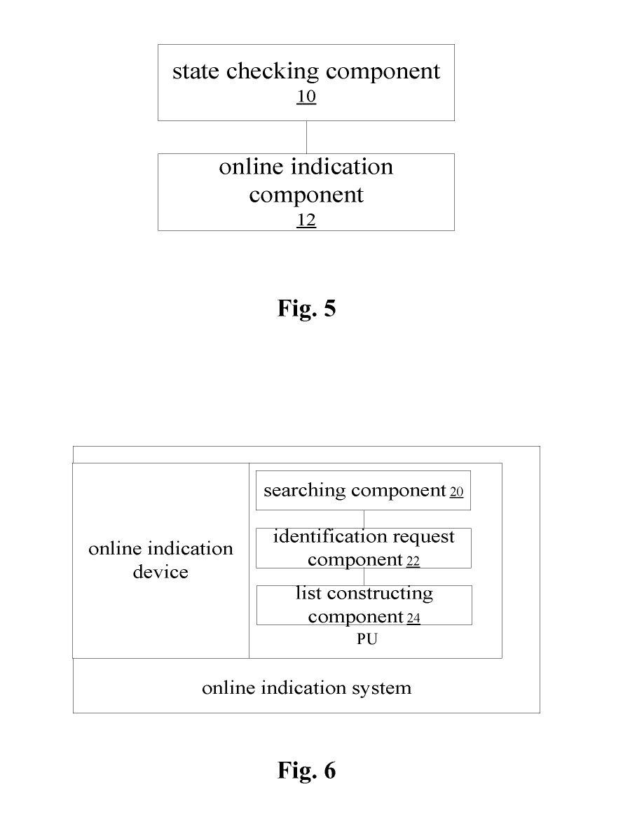

Corresponding to the online indication method provided in the above-mentioned embodiments, the present embodiment provides an online indication device, and the device may be provided on a video monitoring system side for realizing the above-mentioned embodiment. FIG. 5 is a structure diagram of an online indication device according to an embodiment of the invention, and as shown in FIG. 5, the device comprises: a state checking component 10 and an online indication component 12. The structure is described below.

A state checking component 10 is configured to check an online state of each PU in a designated area.

An online indication component 12 is connected to the state checking component 10, and configured to, based on that the state checking component 10 checks that there is an offline PU, send indication information to the above-mentioned offline PU, wherein the indication information is used for indicating that the above-mentioned offline PU automatically starts online.

By means of the above-mentioned device, offline PUs within a certain area may be found according to physical location information of the PUs, then the above-mentioned offline PUs are automatically online when receiving the indication information, and the problem in the related art that the PUs cannot automatically start online in the case of emergency after being offline is solved, and thus, there is no need for users to start the PUs manually, which is greatly convenient for the users, and can ensure that all the PUs in a critical area are in a normal working state in case of emergency, and improves the working performance of the PUs.

In the above-mentioned state checking component 12, a checking operation for checking the online states of the PUs may be periodically executed, or may be executed when a triggering condition is received. One embodiment provides a preferred embodiment, that is, the above-mentioned device further comprises: an alarm receiving component configured to receive an alarm message of the PU; and a searching component configured to search for the above-mentioned each PU in the designated area where the above-mentioned PU is located. Through the structure, the alarm message of the PU plays the role of triggering to execute a checking operation, and after one or more PUs in the area in which the checking operation is performed are found, the online states of the one or more Pus are checked.

Preferably, before receiving the alarm message of the PU, the above-mentioned device further comprises: a list receiving component configured to receive PU list information reported by any PU in a video monitoring system, wherein the PU list information records information about each PU in a designated area where the above-mentioned any PU is located.

Through the above-mentioned structure, received PU list information provides basis for subsequently searching for the PU in the designated area; preferably, the above-mentioned searching component comprises: a searching element configured to, through the above-mentioned PU list information, search for the above-mentioned each PU in the designated area where the above-mentioned PU is located.

After receiving the PU list information reported by any PU, the PU list information corresponding to the PU may be updated, or the PU list information corresponding to other PUs in the PU list information also may be updated, that is, it may be understood as updating the PU list information corresponding to any PU. For this, the present embodiment provides a preferred embodiment, that is, the above-mentioned device further comprises: a list updating component configured to update PU list information corresponding to any PU. Through the structure, the accuracy of searching for the PU is improved.

Preferably, the above-mentioned online indication component 12 is configured to send, via a short message interface, the above-mentioned indication information to the above-mentioned offline PU in a manner of inputting a mobile user number of the offline PU. Preferably, the above-mentioned online indication component 12 is configured to send an indication message to the offline PU through a mobile network.

Corresponding to the online indication method provided in the above-mentioned embodiment, the present embodiment provides an online indication system, and the system is provided for realizing the above-mentioned embodiment. FIG. 6 is a structure diagram of an online indication system according to an embodiment of the invention, and as shown in FIG. 6, the system comprises: an online indication device provided in the above-mentioned embodiment, and a PU. The PU comprises: a searching component 20, an identification request component 22 and a list constructing component 24. The structure is described below.

A searching component 20 is configured to search for each PU in an area where the above-mentioned PU is located.

An identification request component 22 is connected to the searching component 20 and configured to send a request message to each searched PU, wherein the request message is used for requesting acquiring an ID of the above-mentioned each PU.

A list constructing component 24 is connected to the identification request component 22 and configured to construct the above-mentioned PU list information according to the acquired ID mentioned above.

By means of the above-mentioned system, offline PUs within a certain area may be found according to physical location information of the PUs, then the above-mentioned offline PUs are automatically online according to the indication information, and the problem in the related art that the PUs cannot automatically start online in the case of emergency after being offline is solved, and thus, there is no need for users to start the PUs manually, which is greatly convenient for the users, and can ensure that all the PUs in a critical area are in a normal working state in case of emergency, and improves the working performance of the PUs.

After the list constructing component 24 constructs the PU list information, the above-mentioned PU further comprises: a list reporting component configured to report the constructed PU list information mentioned above to the above-mentioned online indication device. Preferably, the above-mentioned searching component 20 may search for at least one PU which is located in the area thereof through WIFI.

It can be seen from the above description that in the embodiments of the invention, there is no need for users to start the PUs manually, so that it is greatly convenient for the users. In addition, the embodiments of the invention can ensure that all the PUs in a critical area are in a normal working state in case of emergency, thus improving the working performance of the PUs.

Apparently, those skilled in the art shall understand that the above components and steps of the invention can be realized by using general purpose calculating device, can be integrated in one calculating device or distributed on a network which consists of a plurality of calculating devices, and alternatively they can be realized by using the executable program code of the calculating device, so that consequently they can be stored in the storing device and executed by the calculating device, in some cases, can perform the shown or described step in sequence other than herein, or they are made into integrated circuit component respectively, or a plurality of components or steps thereof are made into one integrated circuit component. In this way, the invention is not restricted to any particular hardware and software combination.

The above description is only preferred embodiments of the invention and is not intended to limit the invention, and the invention can have a variety of changes and modifications for ordinary person skilled in the field. Any modification, equivalent replacement, or improvement made within the spirit and principle of the invention shall all fall within the protection scope of the invention.

1. An online indication method, comprising:
checking an online state of each video coder (PU) in a designated area; and
based on that there is an offline PU, sending indication information to the offline PU, wherein the indication information is used for indicating that the offline PU automatically starts online.

2. The method according to claim 1, wherein before checking the online state of each PU in a designated area, the method further comprises: receiving an alarm message of a PU; and searching for the each PU in the designated area where the PU is located.

3. The method according to claim 2, wherein before receiving the alarm message of the PU, the method further comprises:
receiving PU list information reported by any PU in a video monitoring system, wherein the PU list information records information about each PU in the designated area where the any PU is located.

4. The method according to claim 3, wherein before receiving the PU list information reported by the any PU, the method further comprises:
the any PU searching for PUs which are located in the area where the any PU is located;
the any PU sending a request message to at least one searched PU, wherein the request message is used for requesting acquiring at least one identity (ID) of the at least one searched PU; and
the any PU constructing the PU list information according to the at least one acquired ID.

5. The method according to claim 3, wherein searching for the each PU in the area where the PU is located comprises:
according to the PU list information, searching for the each PU in the designated area where the PU is located.

6. The method according to claim 3, wherein after receiving the PU list information reported by the any PU, the method further comprises:
updating the PU list information corresponding to the any PU.

7. The method according to claim 1, wherein sending the indication information to the offline PU comprises:
in a manner of inputting a mobile phone number of the offline PU sending, via a short message interface, the indication information to the offline PU.

8. The method according to claim 1, wherein sending the indication information to the offline PU comprises:
sending the indication information to the offline PU via a mobile network.

9. The method according to claim 5, wherein the any PU searching for the at least one PU which is located in the area where the any PU is located comprises:
the any PU searching, through Wireless Fidelity (WIFI), for the at least one PU which is located in the area where the any PU is located.

10. An online indication device, comprising:
a state checking component configured to check an online state of each video coder (PU) in a designated area; and
an online indication component configured to, based on that the state checking component checks that there is an offline PU, send indication information to the offline PU, wherein the indication information is used for indicating that the offline PU automatically starts online.

11. The online indication device according to claim 10, wherein the device further comprises:
an alarm receiving component configured to receive an alarm message of the PU; and
a searching component configured to search for the each PU in the designated area where the PU is located.

12. The online indication device according to claim 11, wherein the device further comprises:
a list receiving component configured to receive PU list information reported by any PU in a video monitoring system, wherein the PU list information records information about each PU in the designated area where the any PU is located.

13. The online indication device according to claim 12, wherein the searching component comprises:
a searching element configured to, according to the PU list information, search for the each PU in the designated area where the PU is located.

14. The online indication device according to claim 12, wherein the device further comprises:
a list updating component configured to update the PU list information corresponding to the any PU.

15. An online indication system, comprising: an online indication device as claimed in claim 10, and a video coder (PU), the PU comprising:
a searching component configured to search for each PU in an area where the PU is located;
an identification request component configured to send a request message to each searched PU, wherein the request message is used for requesting acquiring identity (ID) of the each PU; and
a list constructing component configured to construct PU list information according to the acquired ID.

16. The online indication system according to claim 15, wherein the PU further comprises:
a list reporting component configured to report the constructed PU list information to the online indication device.
